(19) United States
(12) Patent Application Publication
(10) Pub. No.: US 2012/0001961 A1
(43) Pub. Date: Jan. 5, 2012

(54) IMAGE DISPLAY DEVICE

(75) Inventors: Yasuo NISHIKAWA, Nagoya-shi (JP); Norimi YASUE, Nagoya-shi (JP)

(73) Assignee: BROTHER KOGYO KABUSHIKI KAISHA, Nagoya-shi (JP)

(21) Appl. No.: 13/230,558

(22) Filed: Sep. 12, 2011

Related U.S. Application Data
(63) Continuation-in-part of application No. PCT/JP2010/054584, filed on Mar. 17, 2010.

(30) Foreign Application Priority Data
Mar. 18, 2009 (JP) 2009-066513

(51) Int. Cl. G09G 5/10

(52) U.S. Cl. 345/690

(57) ABSTRACT

A drive signal generation part of an image display device includes a memory unit which stores data on a first waveform for scanning light out of a sawtooth waveform of a drive signal, and stores data on a second waveform which is a waveform formed by excluding the first waveform from the sawtooth waveform of the drive signal, and the drive signal generation part sequentially reads data on the first waveform from the memory unit at readout timing corresponding to resonance frequency of a high-speed scanning element and generates a portion of a drive signal corresponding to the first waveform, and sequentially reads data on a plurality of second waveforms stored in the memory unit corresponding to the resonance frequency of the high-speed scanning element and generates portions of the drive signal corresponding to the second waveforms corresponding to the resonance frequency of the high-speed scanning element.

### CROSS-REFERENCE TO RELATED APPLICATIONS

The present application is a Continuation-in-Part of the International Application PCT/JP2010/054584 filed on Mar. 17, 2010, which claims the benefits of Japanese Patent Application No. 2009-066513 filed on Mar. 18, 2009.

### BACKGROUND OF THE INVENTION

1. Field

The present invention relates to an image display device which displays an image by scanning light corresponding to an image signal two-dimensionally.

2. Description of the Related Art

Conventionally, there has been known an optical scanning image display device which displays an image by scanning light generated based on an image signal (hereinafter referred to as “image light”) two-dimensionally using an optical scanning element such as a Galvano mirror.

This type of image display device displays, in general, a two-dimensionally scanned image by horizontally scanning the image light using a reflection mirror of an optical scanning element which scans the image light at a high speed (hereinafter referred to as “high-speed scanning element”) and, then, by vertically scanning the horizontally-scanned image light using a reflection mirror of an optical scanning element which scans the image light at a low speed (hereinafter referred to as “low-speed scanning element”).

For example, JP-A-2003-302590 discloses an image display device in which an image light is horizontally scanned by resonating a reflection mirror of a resonance-type high-speed scanning element (main scanning element) at resonance frequency fr, and the horizontally-scanned image light is vertically scanned by forcibly oscillating a reflection mirror of a low-speed scanning element (sub scanning element) in response to drive signals having a sawtooth waveform thus eventually forming a two-dimensionally scanned image.

In such an image display device, it is necessary to synchronize drive frequency of the reflection mirror of the low-speed scanning element with the resonance frequency fr of the high-speed scanning element. However, it is often the case where the resonance frequency fr of the high-speed scanning element deviates from a designed value due to individual differences (irregularities among individual structures) or environmental properties such as temperature.

Accordingly, when a drive frequency (cycle) of the reflection mirror of the low-speed scanning element is generated based on the resonance frequency fr of the high-speed scanning element, a scanning frequency (cycle) of the low-speed scanning element is also deviated along with a change in resonance frequency fr of the high-speed scanning element. For example, when the resonance frequency fr of the high-speed scanning element is increased by 10%, drive frequency (scanning frequency) of the low-speed scanning element which is driven in synchronism with the high-speed scanning element is also increased by 10%. Since vertical synchronous frequency (frame frequency) of an image signal supplied from an external device is set to a fixed value in advance (30 frames/sec or 60 frames/sec in general), when the drive frequency of the low-speed scanning element differs from the vertical synchronous frequency of the above-mentioned image signal, it is necessary to correct the number of frames by erasing a specific frame of the image or by reproducing the same frame twice. The larger the deviation of the drive frequency of the low-speed scanning element from the vertical synchronous frequency, the larger the number of corrections per unit time becomes so that a part of the image which is discontinuous in the time direction becomes conspicuous. This phenomenon becomes particularly conspicuous at a part of the image where the movement (change) of the image is vigorous.

To cope with such a drawback, in a device described in JP-A-2003-302590 (patent document 1), a period acquired by multiplying one scanning cycle of the high-speed scanning element by the number of valid scanning lines is set as a valid scanning period during which an image light is effectively scanned, and a period acquired by subtracting the valid scanning period from a drive cycle of the low-speed scanning element is set as an invalid scanning period during which an image light is not effectively scanned thus setting a drive cycle (frame cycle) of the reflection mirror of the low-speed scanning element to a fixed value.

### SUMMARY

However, in the technique disclosed in the above-mentioned patent document 1, the reflection mirror of the low-speed scanning element is driven by a stepping motor and hence, although the reflection mirror can be easily driven sequentially by a predetermined amount in response to clock signals, the technique has drawbacks including a drawback that the number of scanning lines is large so that a step-out or the like is liable to occur in a high-speed operation. Accordingly, the technique disclosed in the above-mentioned patent document 1 is not applicable to the high-speed operation. Although it is often the case where an electromagnetic optical scanning element is adopted in operating a scanning element at a high speed, the electromagnetic optical scanning element forms a saw-tooth-shaped drive waveform and uses the saw-tooth-shaped drive waveform as a drive signal and hence, it is not possible to apply the technique disclosed in patent document 1 which uses the stepping motor to the electromagnetic optical scanning element.

Further, there may be a case where optical scanning cannot be performed properly when the invalid scanning period is just changed.

For example, when a scanning element in which a reflection mirror is swingably supported on a fixed member by way of beam members having resiliency is used as a low-speed scanning element, the low-speed scanning element has natural resonance frequency determined based on properties of the reflection mirror and properties of the beam members. Accordingly, to consider a case where such a scanning element is used as the low-speed scanning element which is forcibly driven in response to a drive signal, when the drive signal contains resonance frequency intrinsic to the low-speed scanning element, the resonance oscillations of the reflection mirror are induced. Then, due to such resonance oscillations, swinging having undesired frequency components is superimposed on the swinging of the reflection mirror thus giving rise to a state where optical scanning faithful to a drive signal cannot be realized.

It is an object of the present invention to provide an image display device which uses a resonance-type high-speed scanning element and a low-speed scanning element which is forcibly driven in response to a drive signal, wherein the image display device can secure a stable swinging cycle of the low-speed scanning element and can suppress the induction of the resonance oscillations of a reflection mirror of the low-speed scanning element even when resonance frequency of the high-speed scanning element is changed or the individual difference exists in resonance frequency.

To achieve the above-mentioned object, according to one aspect of the present invention, there is provided an image display device which displays an image by two-dimensionally scanning light having intensity corresponding to an image signal, the image display device including: a light source part which irradiates the light having the intensity corresponding to the image signal; a resonance-type high-speed scanning element which scans the light incident on the high-speed scanning element at a relatively high speed in a first direction by a reflection mirror which resonates; a low-speed scanning element which inclines a reflection mirror in a direction corresponding to a signal level of a drive signal to be inputted, and scans the light incident on the low-speed scanning element at a relatively low speed in a second direction approximately perpendicular to the first direction by the reflection mirror; a detection part which detects resonance frequency of the high-speed scanning element; a drive signal generation part which generates a drive signal having a sawtooth waveform corresponding to resonance frequency of the high-speed scanning element; and a low-speed scanning element drive part which inputs the drive signal generated by the drive signal generation part to the low-speed scanning element.

The drive signal generation part includes a memory unit which stores data on a first waveform for effectively scanning light out of a sawtooth waveform of the drive signal, and stores data on a second waveform which is a waveform formed by excluding the first waveform from the sawtooth waveform of the drive signal, and the drive signal generation part sequentially reads data on the first waveform stored in the memory unit at readout timing corresponding to resonance frequency of the high-speed scanning element and to generate a portion of the drive signal corresponding to the first waveform, and sequentially reads data on the second waveform stored in the memory unit at readout timing corresponding to the resonance frequency of the high-speed scanning element and to generate a portion of the drive signal corresponding to the second waveform corresponding to the resonance frequency of the high-speed scanning element thus maintaining a change in a cycle of the sawtooth waveform within a predetermined time.

### BRIEF DESCRIPTION OF DRAWINGS

For a more complete understanding of the disclosure, the needs satisfied thereby, and the objects, features, and advantages thereof, reference now is made to the following description taken in connection with the accompanying drawings.

FIG. 1 is an explanatory view showing the constitution of an image display device according to one embodiment of the present invention;

FIG. 2 is a view for explaining a light scanning mode by an optical scanning part of the image display device shown in FIG. 1;

FIG. 3 is a view for explaining a property of a vertical drive signal used for driving a vertical scanning element of the vertical scanning part shown in FIG. 1;

FIG. 4 is a view for explaining the suppression of a change in vertical scanning frequency of the vertical scanning element of the vertical scanning part shown in FIG. 1;

FIG. 5 is a view for explaining the suppression of a change in vertical scanning frequency of a vertical scanning element of the vertical scanning part shown in FIG. 1;

FIG. 6A is a view for explaining a waveform of the vertical drive signal for driving the vertical scanning element of the vertical scanning part shown in FIG. 1;

FIG. 6B is a view for explaining a waveform of a vertical drive signal for driving the vertical scanning element of the vertical scanning part shown in FIG. 1;

FIG. 7 is a view for explaining a waveform of a vertical drive signal for driving the vertical scanning element of the vertical scanning part shown in FIG. 1;

FIG. 8 is a view for explaining a waveform of a vertical drive signal for driving the vertical scanning element of the vertical scanning part shown in FIG. 1;

FIG. 9A is a view for explaining a waveform of a vertical drive signal for driving the vertical scanning element of the vertical scanning part shown in FIG. 1;

FIG. 9B is a view for explaining a waveform of a vertical drive signal for driving the vertical scanning element of the vertical scanning part shown in FIG. 1;

FIG. 9C is a view for explaining a waveform of a vertical drive signal for driving the vertical scanning element of the vertical scanning part shown in FIG. 1;

FIG. 10 is a view for explaining a waveform of a vertical drive signal for driving the vertical scanning element of the vertical scanning part shown in FIG. 1;

FIG. 11 is an explanatory view of a brightness table stored in a third ROM shown in FIG. 1; and

FIG. 12 is an operational flowchart showing a control of an optical scanning part by a control part shown in FIG. 1.

### DESCRIPTION

Hereinafter, preferred embodiments of the present invention are explained in conjunction with drawings. Hereinafter, the explanation is made by mainly focusing on a case where an image display device is constituted of a retinal scanning display. The image display device includes: a light source part which irradiates light with intensity corresponding to an image signal; an optical scanning part which two-dimensionally scans the light irradiated from the light source part; and a control part which controls the light source part and the optical scanning part. The image display device projects an image by directly projecting the light which is scanned by the optical scanning part onto a retina of at least one eye of a user who is an observer thus displaying an image on the retina. However, the present invention is not limited to such an image display device, and the present invention is also applicable to other image display devices which display an image by scanning light including an image projector which displays an image by projecting light scanned by an optical scanning part onto a screen surface, for example.

(Constitution of Image Display Device)

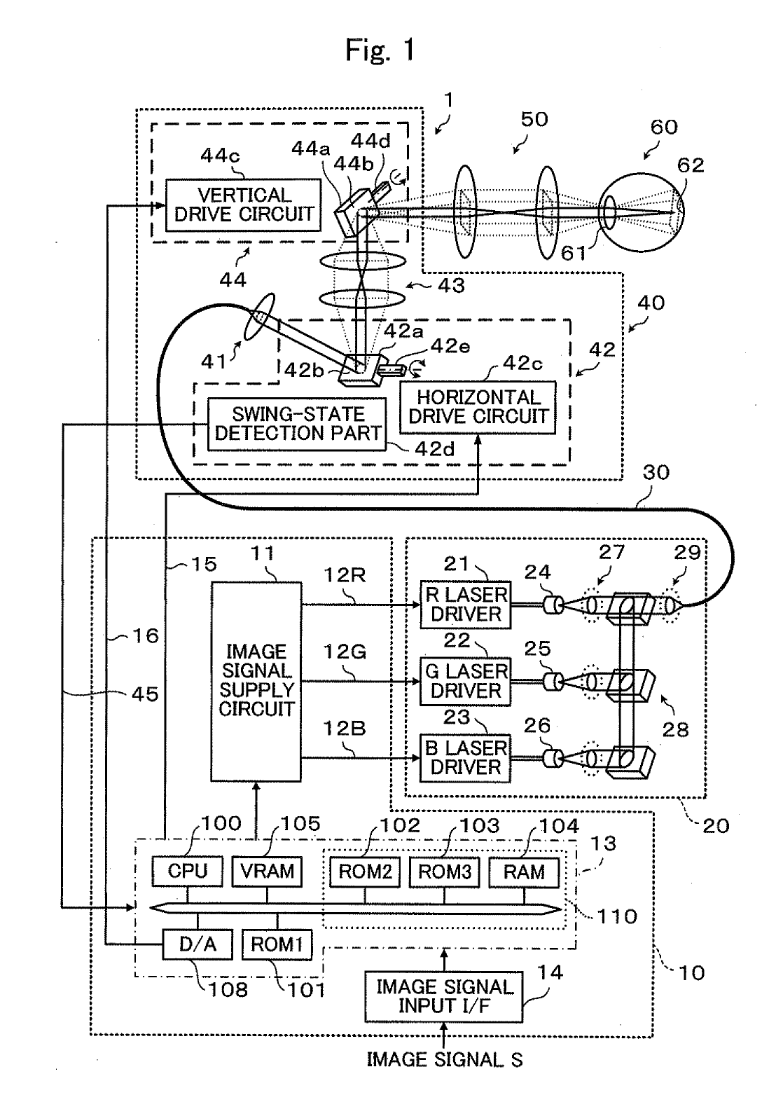

Firstly, the constitution of the retinal scanning display of this embodiment is explained in conjunction with FIG. 1.

An image display device 1 according to this embodiment is an image display device which displays an image by two-dimensionally scanning light corresponding to an image signal S and by directly projecting the light onto a retina of a user who is an observer. As shown in FIG. 1, the image display device 1 includes a display control part 10, a light source part 20, an optical scanning part 40 and a relay optical system 50. The display control part 10 controls respective parts in response to an inputted image signal S. The light source part 20 irradiates light corresponding to the image signal S in accordance with a control performed by the display control part 10. The optical scanning part 40 scans the light irradiated from the light source part 20 two dimensionally. The relay optical system 50 also has a function as an ocular optical system which projects the light scanned by the optical scanning part 40 onto an eye 60 of the user. Here, the light irradiated from the light source part 20 is incident on the optical scanning part 40 through the optical fiber 30.

The display control part 10 includes an image signal supply circuit 11 to which the image signal S is inputted from the outside and which generates an image signal 12R of red (R), an image signal 12G of green (G), and an image signal 12B of blue (B) which constitute elements for synthesizing an image in response to the inputted image signal S, a control part 13 which controls the whole display control part 10, and an image signal input I/F 14 to which the image signal S is inputted from the outside.

The light source part 20 includes an R laser 24, a G laser 25 and a 13 laser 26, and an R laser driver 21, a G laser driver 22 and a B laser driver 23 for driving these lasers 24 to 26 respectively. The light source part 20 further includes collimation optical systems 27 provided for collimating laser beams irradiated from the respective lasers 24 to 26, dichroic mirrors 28 which synthesize the collimated laser beams and an optical system 29 which guides the synthesized laser beams to the optical fiber 30. Here, the lasers 24 to 26 are constituted of a semiconductor laser such as a laser diode or a solid-state laser. The image signal supply circuit 11 of the display control part 10 generates the image signals 12R, 12Q 12B of respective colors based on the image signal S as described above, and inputs the image signals 12R, 12Q 12B into the respective laser drivers 21 to 23. Due to such a constitution, it is possible to irradiate light of a single color or a compound color of red (R), green (G) and blue (B) from the light source part 20. Here, the laser beam which is generated by the light source part 20 and is incident on the optical fiber 30 in this manner is light which is used for forming an image and hence, such a laser beam is referred to as “image light” hereinafter.

The image light which is guided to the optical fiber 30 from the light source part 20 is incident on the optical scanning part 40. The optical scanning part 40 includes a collimation optical system 41 which collimates the image light irradiated from the optical fiber 30, a horizontal scanning part 42 which scans the collimated image light in the horizontal direction (first direction) constituting a main scanning direction at a relatively high speed, a relay optical system 43 which guides the image light scanned in the horizontal direction to a vertical scanning part 44 described later, and the vertical scanning part 44 which scans the image light incident on the vertical scanning part 44 via the relay optical system 43 in the vertical direction (second direction) constituting a sub scanning direction approximately perpendicularly intersecting with the horizontal direction at a relatively low speed. Further, the image light scanned by the optical scanning part 40 in this manner is incident on a pupil 61 of the eye 60 of the user via the relay optical system 50. Here, the relay optical system 50 converts the image light such that scanned optical fluxes are converged at a position of the pupil 61 of the eye 60 of the user.

Here, the horizontal scanning part 42 is an optical system which horizontally scans an image light in a reciprocating manner for every 1 horizontal scanning line of an image to be displayed. The horizontal scanning part 42 includes an optical scanning element 42a having a reflection mirror 42b which is swung in response to a drive signal such as a Galvano mirror (hereinafter referred to as “high-speed scanning element 42a”), a horizontal drive circuit 42c which drives the high-speed scanning element 42a, and a swing-state detection part 42d which detects a swing state of the reflection mirror 42b of the high-speed scanning element 42a. The high-speed scanning element 42a is a resonance-type optical scanning element, and the reflection mirror 42b resonates in response to inputting of a drive signal of resonance frequency which agrees with a resonance characteristic of the high-speed scanning element 42a. Further, the swing-state detection part 42d detects swing frequency of the reflection mirror 42b, magnitude (amplitude) of swing of the reflection mirror 42b, phase difference between a horizontal drive signal 15 and a swing state and the like as a swing state signal 45, and outputs the swing state signal 45 to the control part 13 of the display control part 10. The swing-state detection part 42d includes a beam source and a light detector (beam detector). The swing-state detection part 42d irradiates a beam for detection to the reflection mirror 42b from the beam source, and detects magnitude, swing frequency and a phase of a swing of the reflection mirror 42b based on a detection state and detection timing of a reflection light reflected from the reflection mirror 42b. Here, by mounting a piezoelectric element or the like on a beam member 42e which supports the reflection mirror 42b of the optical scanning element 42a, it is possible to detect magnitude, swing frequency and a phase of a swing of the reflection mirror 42b by converting a change of the beam member 42e into an electric signal.

Further, the vertical scanning part 44 is an optical system which vertically scans the image light from a first horizontal scanning line toward a last horizontal scanning line for every 1 frame of the image to be displayed. The vertical scanning part 44 further includes an optical scanning element 44a having a reflection mirror 44b which is swung in response to a drive signal such as a Galvano mirror (hereinafter referred to as “low-speed scanning element 44a”), and a vertical drive circuit 44c (one example of a low-speed scanning element drive part) which drives the low-speed scanning element 44a. The reflection mirror 44b is inclined in the direction corresponding to a signal level of a drive signal inputted to the low-speed scanning element 44a, and the low-speed scanning element 44a scans incident light in the vertical direction by the reflection mirror 44b. The reflection mirror 44b of the low-speed scanning element 44a is swingably supported on a fixed member by way of a beam member 44d having resiliency. The low-speed scanning element has a natural resonance frequency which is determined based on material properties and size/shape properties of the reflection mirror 44b and the beam member 44d.

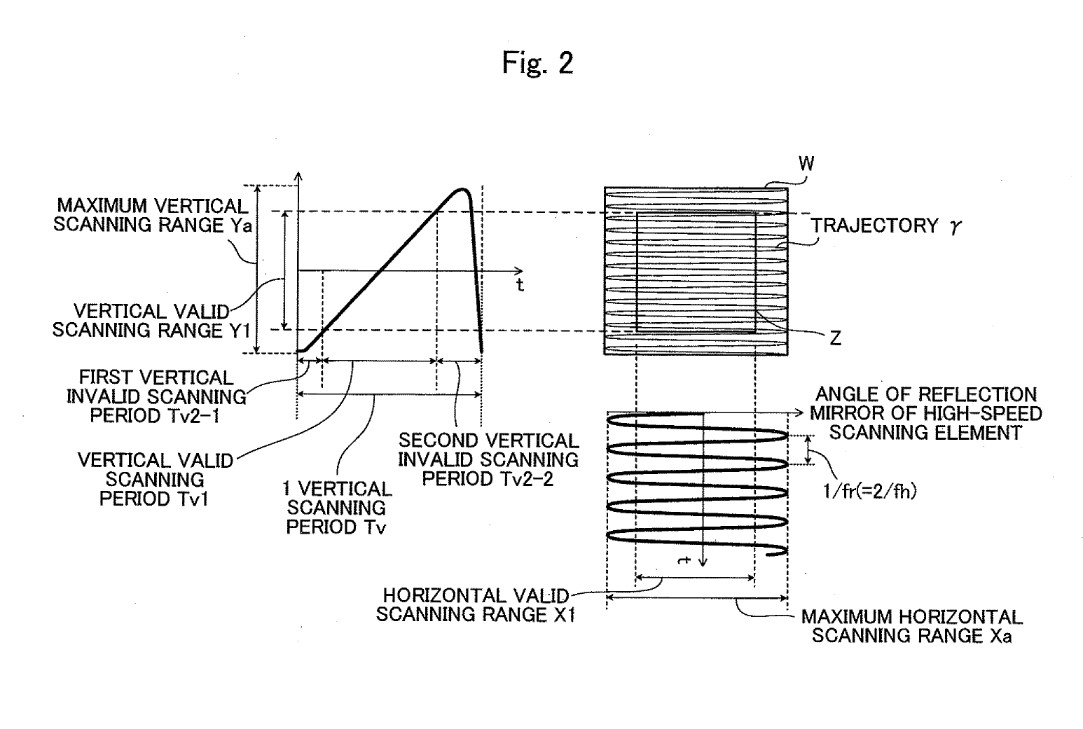

FIG. 2 shows the relationship between a maximum scanning range W (a range defined by a maximum horizontal scanning range Xa and a maximum vertical scanning range Ya shown in FIG. 2) and a valid scanning range Z (a range defined by a horizontal valid scanning range X1 and a vertical valid scanning range Y1 shown in FIG. 2) both of which are obtained by the high-speed scanning element 42a of the horizontal scanning part 42 and the low-speed scanning element 44a of the vertical scanning part 44. Here, the “maximum scanning range” means a maximum range where image light can be scanned by the high-speed scanning element 42a of the horizontal scanning part 42 and the low-speed scanning element 44a of the vertical scanning part 44.

The horizontal drive circuit 42c amplifies the horizontal drive signal 15 outputted from the display control part 10, and applies the amplified horizontal drive signal 15 to the high-speed scanning element 42a thus driving the reflection mirror 42b of the high-speed scanning element 42a. The vertical drive circuit 44c amplifies the vertical drive signal 16 outputted from the display control part 10, and applies the amplified vertical drive signal 16 to the low-speed scanning element 44a thus forcibly driving the reflection mirror 44b of the low-speed scanning element 44a. The display control part 10 allows the light source part 20 to irradiate the image light whose intensity is modulated in response to the image signal S when the scanning position of the high-speed scanning element 42a and the scanning position of the low-speed scanning element 44a fall within the valid scanning range Z in the maximum scanning range W of the high-speed scanning element 42a and the low-speed scanning element 44a. Due to such processing, the image light is scanned within the valid scanning range Z by the high-speed scanning element 42a and the low-speed scanning element 44a respectively and hence, the image light for 1 frame is scanned within the valid scanning range Z. This scanning is repeated for every image of 1 frame. In FIG. 2, a trajectory γ of the image light to be scanned by the high-speed scanning element 42a and the low-speed scanning element 44a, assuming that the image light is constantly irradiated from the light source part 20, is virtually shown. However, the number of scanning lines in the horizontal scanning direction X performed by the high-speed scanning element 42a is several hundreds to about a thousand for every 1 frame so that the trajectory γ of the image light is described in a simplified manner in FIG. 2 to facilitate the recognition of the scanning lines.

Further, the control part 13 includes a CPU (Central Processing Unit) 100, first to third ROMs (Read Only Memory) 101 to 103, a RAM (Random Access Memory) 104, a VRAM (Video Random Access Memory) 105 in which image data to be displayed is stored, and a digital analogue converter (D/A converter) 108. In the explanation made hereinafter, the second and third ROMs 102, 103 and the RAM 104 may be collectively referred to as the memory unit 110.

Then, the CPU 100, the first to third ROMs 101 to 103, the RAM 104, the VRAM 105 and the D/A converter 108 are respectively connected to a bus for data communication, and the transmission/reception of various information is performed via the bus for data communication.

The CPU 100 performs various functions as the control part 13 by executing various information processing programs stored in the first ROM 101. For example, the control part 13, as a drive signal generation part, generates a horizontal drive signal 15 of frequency (resonance frequency fr of high-speed scanning element 42a) at which the reflection mirror 42b resonates based on the swing state signal 45 containing information on swing frequency, a magnitude and a phase of a swing and the like of the reflection mirror 42b inputted from the swing state detection part 42d, and resonates the reflection mirror 42b of the high-speed scanning element 42a. Further, the control part 13, as the drive signal generation part, generates and outputs a vertical drive signal 16 based on the resonance frequency fr of the high-speed scanning element 42a detected by the swing state detection part 42d. Still further, the control part 13 develops image data on respective pixels which constitute an image corresponding to an image signal S inputted to the control part 13 via the image signal input I/F 14 in the VRAM 105, and outputs the image data on the respective pixels to the image signal supply circuit 11 at timing synchronous with the horizontal drive signal 15 and a vertical drive signal 16. The image data is subjected to D/A conversion by the image signal supply circuit 11, and is outputted to the laser drivers 21 to 23 of respective colors as image signals 12R, 12G, 12B.

(Manner of Operation of Control Part 13 as Drive Signal Generation Part)

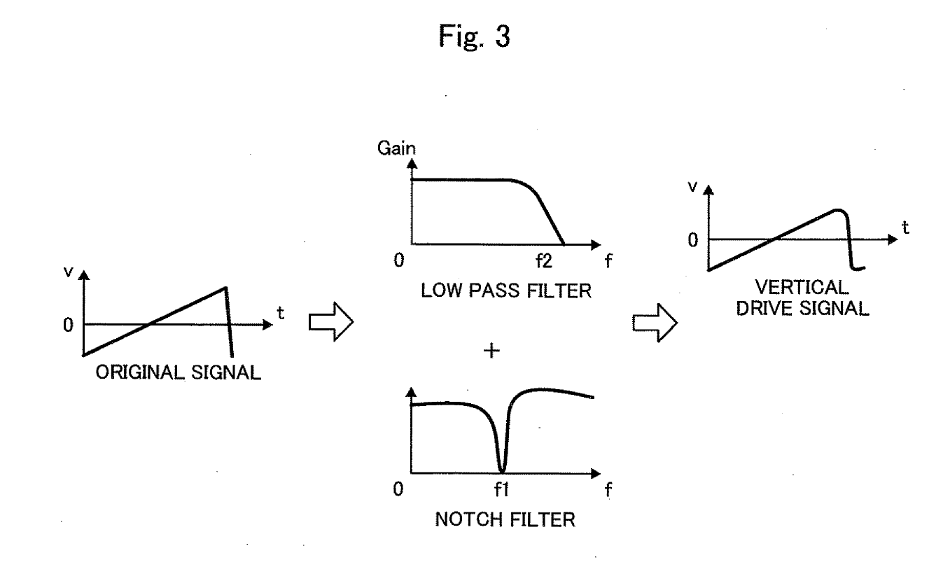

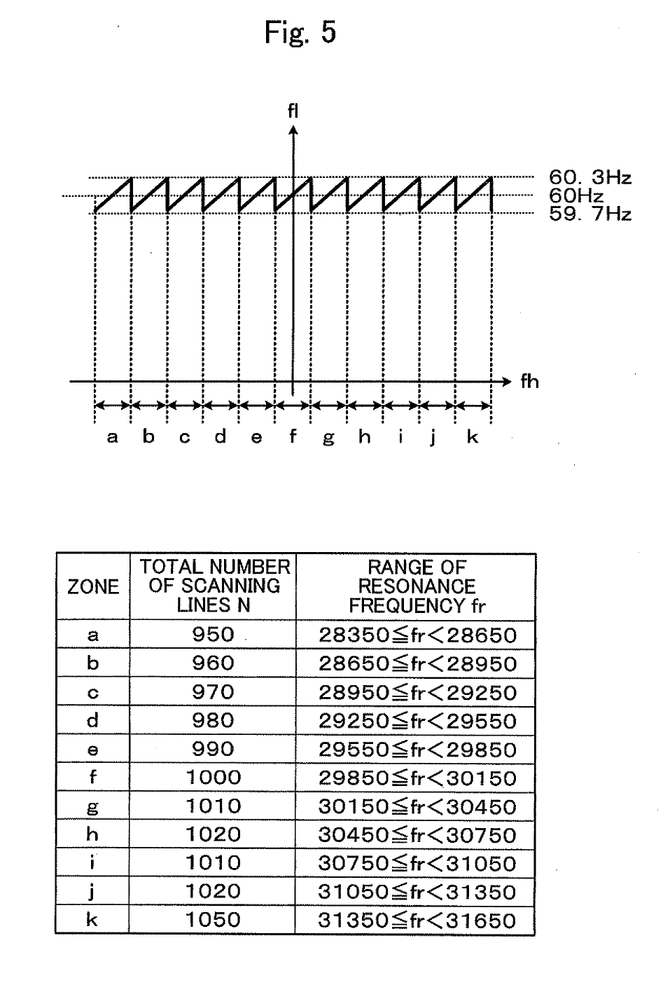

Next, the manner of operation of the control part 13 in which the control part 13 generates the vertical drive signal 16 as the drive signal generation part is explained specifically in conjunction with FIG. 3 to FIG. 10.

(Property of Vertical Drive Signal 16)

Firstly, the property of the vertical drive signal 16 which the control part 13 generates as the drive signal generation part is explained.

The reflection mirror 44b of the low-speed scanning element 44a is swingably supported on the fixed member by way of the beam member 44d having resiliency and hence, the reflection mirror 44b has a natural resonance frequency which is determined based on material properties and size/shape properties of the reflection mirror 44b and the beam member 44d. Accordingly, when the vertical drive signal 16 contains the natural resonance frequency of the low-speed scanning element 44a, the reflection mirror generates resonance oscillations. Due to these resonance oscillations, undesired high frequency components are superposed on swinging of the reflection mirror thus giving rise to a state where optical scanning cannot be performed properly.

Accordingly, as shown in FIG. 3, the vertical drive signal 16 is formed of a sawtooth waveform signal which is formed by applying low pass filter processing and notch filter processing to a sawtooth waveform signal which changes linearly as an original signal.

For example, as resonance characteristics intrinsic to the low-speed scanning element 44a, assume that the first-order resonance frequency is f1 [Hz] and second-and-higher-order resonance frequencies are f2[Hz] or more. In this case, by applying low pass filter processing which attenuates frequency of f2 (>f1)[Hz] or more to a sawtooth waveform signal, the influence exerted by the second-and-higher-order resonances in the resonance characteristics intrinsic to the low-speed scanning element 44a can be suppressed. Further, by applying notch filter processing which attenuates frequencies around frequency of f1[Hz] which forms the center frequency to the sawtooth waveform signal, the influence exerted by the first-order resonance in the resonance characteristic intrinsic to the low-speed scanning element 44a can be suppressed.

In this manner, by using the sawtooth waveform signal which is formed by applying low pass filter processing and notch filter processing to the sawtooth waveform signal which changes linearly as the vertical drive signal 16, the resonance frequency component in the vertical drive signal 16 intrinsic to the low-speed scanning element 44a can be decreased and hence, the resonance oscillations of the reflection mirror 44b can be suppressed. Accordingly, it is possible to obviate a state where a high frequency component is superposed on swinging of the reflection mirror due to the resonance oscillations so that optical scanning cannot be performed properly.

(Vertical Scanning Frequency f1)

Next, the explanation is made with respect to the point that the vertical drive signal 16 which the control part 13 generates as the drive signal generation part can suppress a change in vertical scanning frequency f1 of the low-speed scanning element 44a within a predetermined range.

Here, assume that the resolution of a display image is 800×600 pixels, a designed value of resonance frequency fr of the high-speed scanning element 42a is 30 kHz (the designed value of horizontal scanning frequency becoming 60 kHz which is twice as large as 30 kHz since scanning is performed in a reciprocating manner in the horizontal direction), a designed value of vertical scanning frequency f1 is 60 Hz, and a designed value of the number of times that the reflection mirror 44b of the high-speed scanning element 42a swings in the horizontal direction per 1 vertical scanning period Tv of the low-speed scanning element 44a (see FIG. 2), that is, the number of scanning lines which the high-speed scanning element 42a can form per 1 vertical scanning period Tv (hereinafter referred to as “total number of scanning lines N”) is 1000. Further, assume that an image size of a display image is approximately fixed, and irregularities in the resonance frequency fr of the high-speed scanning element 42a is ±5% (30 kHz±1500 Hz).

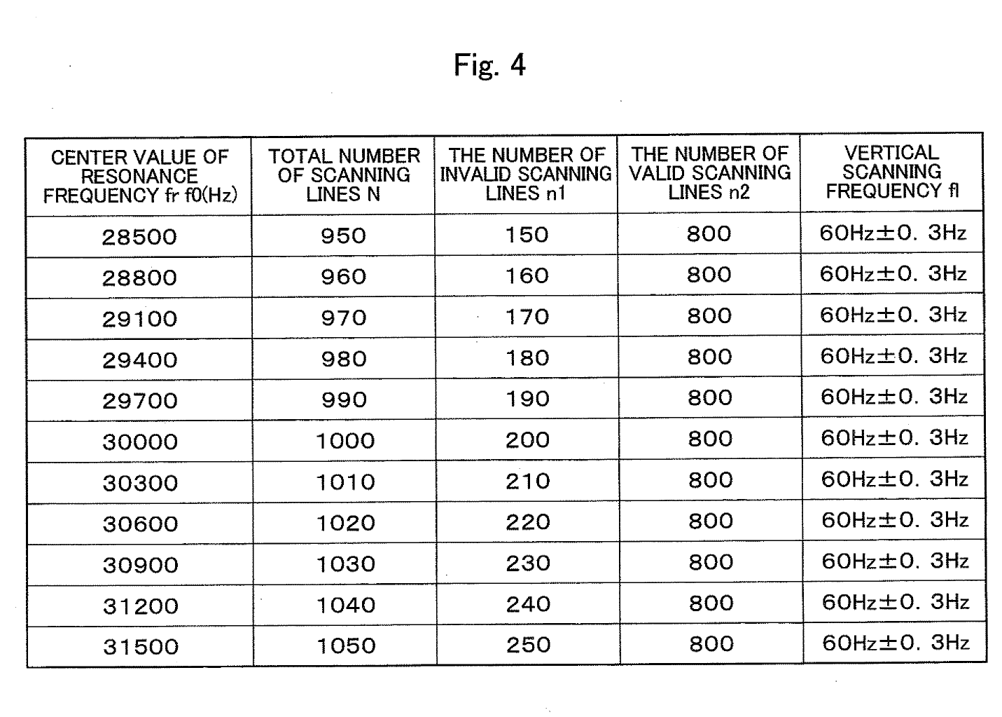

As shown in FIG. 4, by changing the total number of scanning lines N by changing the number of invalid scanning lines n1 with which the high-speed element 42a does not scan light corresponding to resonance frequency fr of the high-speed scanning element 42a, the change in 1 vertical scanning frequency f1 of the low-speed scanning element 44a is suppressed within a predetermined range. Here, the number of invalid scanning lines n1 is a value obtained by subtracting the number of scanning lines along which the high-speed scanning element 42a actually scans an image light (hereinafter referred to as “the number of valid scanning lines n2”) from the total number of scanning lines N. Here, the number of valid scanning lines n2 becomes 800 since the resolution of the display image is 800×600 pixels.

In this manner, by changing the number of invalid scanning lines n1 with a change of approximately 1% (300 Hz) of resonance frequency fr set as 1 unit, vertical scanning frequency f1 of the low-speed scanning element 44a can be suppressed to frequency within ±0.5% (60±0.3 Hz) without changing the number of valid scanning lines n2 from 800 as shown in FIG. 4.

In the image display device 1 according to this embodiment, as described above, the frequency (vertical scanning frequency f1) of the vertical drive signal 16 is set to an approximately fixed value, and 1 vertical scanning period Tv is set to an approximately fixed value.

However, since the number of invalid scanning lines n1 is changed corresponding to resonance frequency fr of the high-speed scanning element 42a, a ratio between the number of invalid scanning lines n1 and the number of valid scanning lines n2 is changed.

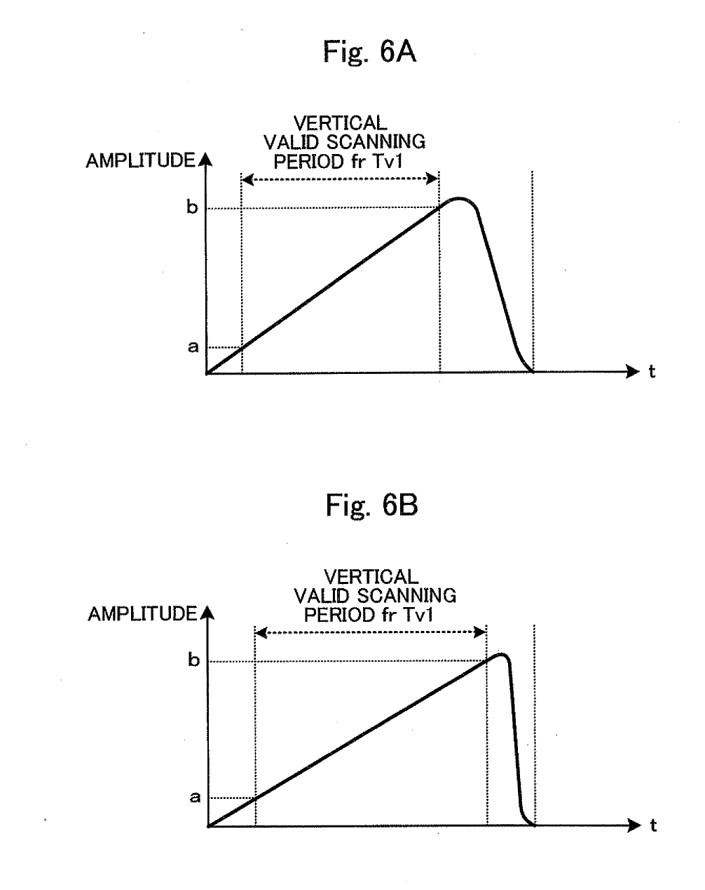

Accordingly, when resonance frequency fr of the high-speed element 42a is high, the number of invalid scanning lines n1 is increased and hence, a vertical drive signal 16 having a waveform where 1 vertical valid scanning period Tv1 becomes short as shown in FIG. 6A becomes necessary. On the other hand, when resonance frequency fr of the high-speed scanning element 42a is low, the number of invalid scanning lines n1 is decreased and hence, a vertical drive signal 16 having a waveform where 1 vertical valid scanning period Tv1 is prolonged as shown in FIG. 6B becomes necessary. To set an image size of a display image to an approximately fixed value, an inclination range of the high-speed scanning element 42a is set to an approximately fixed range (a range from amplitude a to b in FIG. 6A and FIG. 6B).

In the above-mentioned explanation, the number of invalid scanning lines n1 is changed with the change of approximately ±1% of resonance frequency fr set as 1 unit (in accordance with every 10 horizontal scanning lines). However, the change in the number of invalid scanning lines n1 is not limited to such a case. For example, the number of invalid scanning lines n1 may be changed with a change of approximately 0.1% of resonance frequency fr set as 1 unit (in accordance with every 1 horizontal scanning line). That is, the number of invalid scanning lines n1 is increased or decreased in accordance with every 1 horizontal scanning line. Accordingly, a change in a swing cycle of the low-speed scanning element (low-speed scanning cycle) caused by a change in resonance frequency of the high-speed scanning element can be set as a change within a cycle time of 1 scanning by the high-speed scanning element 42a, that is, within a time (1/fh) which is ½ of a swing cycle (period of 1/fr shown in FIG. 2) of the high-speed scanning element 42a and hence, a change in swing cycle of the low-speed scanning element can be suppressed most.

Particularly, by changing the number of total scanning lines N in accordance with the time (1/fh) which is ½ of the swing cycle (1/fr) of the high-speed scanning element 42a or in accordance with a time which is integer times (n/fh: n being an integer of 2 or more) as long as the time (1/fh), the vertical scanning frequency of the low-speed scanning element 44a can be defined by the number of horizontal scanning lines scanned by the high-speed scanning element 42a.

In the image display device 1 according to this embodiment, the cycle of the vertical drive signal 16 is set to an approximately fixed value by changing the waveform of the vertical drive signal 16 corresponding to the resonance frequency fr of the high-speed scanning element 42a in this manner, and a plurality of waveform data on the vertical drive signal 16 are stored in the second and third ROMs 102, 103. This technical feature is specifically explained hereinafter.

(Storing of Data on Vertical Drive Signal 16)

The explanation is made with respect to the technical feature that the control part 13, as the drive signal generation part, divides data on the sawtooth waveform for generating the vertical drive signal 16 into data on first waveform and data on second waveform, and stores these data in the second and third ROMs 102, 103.

Data on the vertical drive signal 16 is stored in such a manner that the sawtooth waveform, of the vertical drive signal 16 for 1 cycle (1 vertical scanning period Tv) is divided into a first waveform W1 and second waveforms W2, W2′, and these waveforms are stored in the memory unit 110 (second and third ROMs 102, 103).

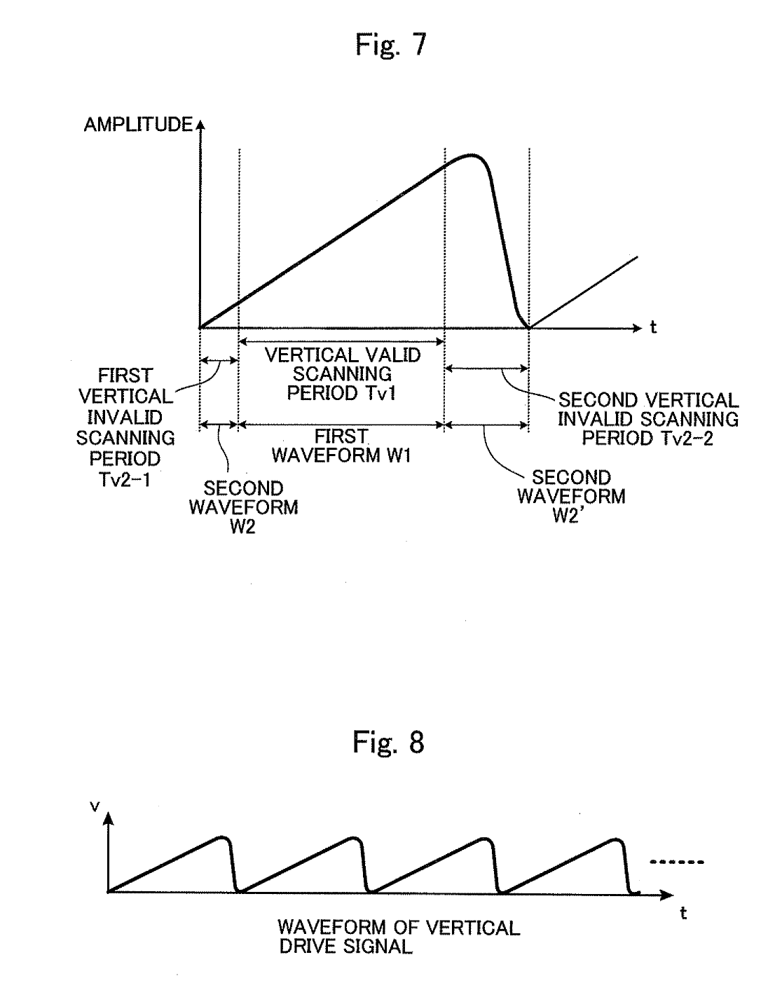

As shown in FIG. 7, the first waveform W1 is a waveform for scanning light out of the sawtooth waveform of the vertical drive signal 16 for 1 cycle, and is a waveform of the vertical drive signal 16 during a vertical valid scanning period Tv1. The second waveforms W2, W2′ are waveforms of the sawtooth waveform of the vertical drive signal 16 for 1 cycle excluding the first waveform W1. The waveform of the vertical drive signal 16 during a first vertical invalid scanning period Tv2-1 is the second waveform W2, and the waveform of the vertical drive signal 16 during a second vertical invalid scanning period Tv2-2 is the second waveform W2′. Data on the first waveform W1 is stored in the second ROM 102, and data on the second waveforms W2, W2′ is stored in the third ROM 103.

The CPU 100 reads data on the first waveform W1 and data on the second waveforms W2, W2′ from the second and third ROMs 102, 103, generates drive signal data using these data, and stores the drive signal data in the RAM 104. Then, the CPU 100 generates the vertical drive signal 16 for 1 cycle by converting the drive signal data stored in the RAM 104 into an analog signal by a D/A converter 108 (FIG. 1). By repeating this processing, the CPU 100 generates the continuous vertical drive signal 16 having a sawtooth waveform as shown in FIG. 8.

(First Waveform W1)

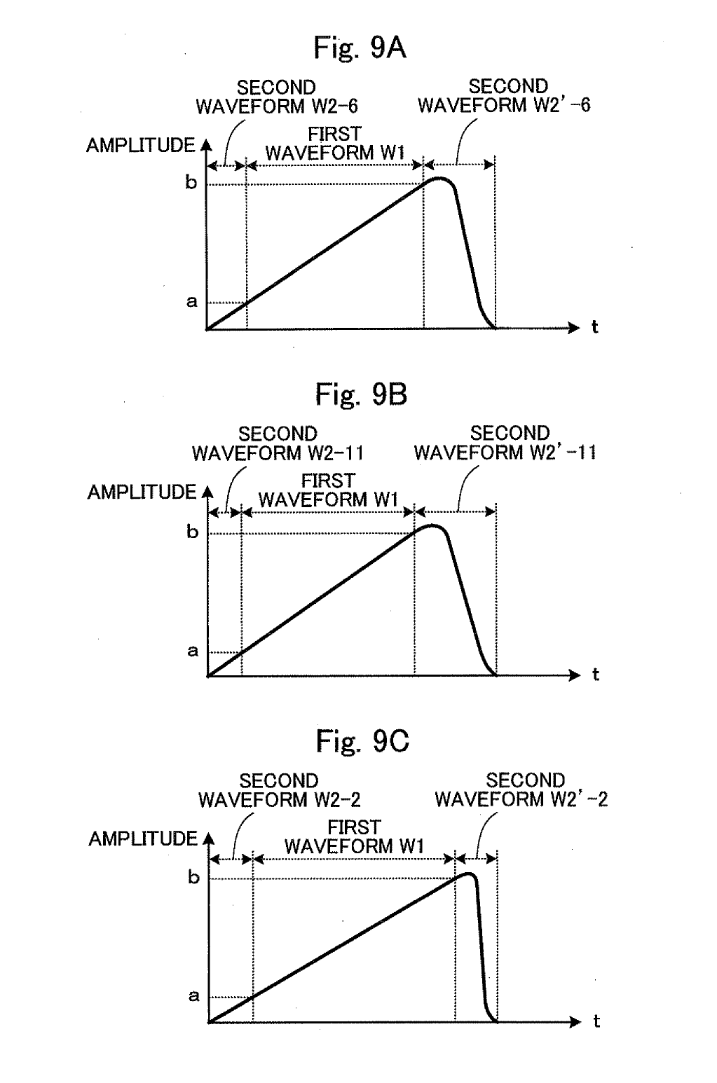

As the first waveform W1 stored in the second ROM 102 of the memory unit 110, one kind of waveform is stored. To set a size of a display image to an approximately fixed value, it is necessary to change the inclination of the first waveform W1 portion of the vertical drive signal 16 corresponding to the resonance frequency fr of the high-speed scanning element 42a. For example, it is necessary to set the inclination of the first waveform W1 when the resonance frequency fr of the high-speed scanning element 42a is 31500 Hz (see FIG. 9B) steeper than the inclination of the first waveform W1 when the resonance frequency fr of the high-speed scanning element 42a is 30000 Hz which is a designed value (see FIG. 9A), and it is also necessary to set the inclination of the first waveform W1 when the resonance frequency fr of the high-speed scanning element 42a is 28800 Hz (see FIG. 9C) gentler than the inclination of the first waveform W1 when the resonance frequency fr of the high-speed scanning element 42a is 30000 Hz which is the designed value (see FIG. 9A).

Accordingly, the CPU 100 of the control part 13 sequentially reads data on the first waveform W1 from the second ROM 102 at readout timing with the cycle (=1/fh) corresponding to the horizontal scanning frequency fh of the high-speed scanning element 42a (=resonance frequency fr×2), and changes the inclination of the first waveform W1 portion of the vertical drive signal 16 corresponding to the resonance frequency fr of the high-speed scanning element 42a.

For example, assuming that data on one first waveform W1 is constituted of 800 pieces of data, data is sequentially read from the second ROM 102 for every 1/60000 seconds (=1/fh) when the resonance frequency fr of the high-speed scanning element 42a is 30000 Hz which is the designed value, and all data on the first waveform W1 is read within 8/600 seconds. On the other hand, data is sequentially read from the second ROM 102 for every 1/63000 seconds (=1/fh) when the resonance frequency fr of the high-speed scanning element 42a is 31500 Hz, and all data on the first waveform W1 is read within 8/630 seconds. Accordingly, the inclination of the first waveform W1 portion of the vertical drive signal 16 becomes steeper compared to the case where the resonance frequency fr of the high-speed scanning element 42a is 30000 Hz. Further, data is sequentially read from the second ROM 102 for every 1/57600 seconds (=UN when the resonance frequency fr of the high-speed scanning element 42a is 28800 Hz, and all data on the first waveform W1 is read within 8/576 seconds. Accordingly, the inclination of the first waveform W1 portion of the vertical drive signal 16 becomes gentler compared to the case where the resonance frequency fr of the high-speed scanning element 42a is 30000 Hz.

Readout timing of data on the first waveform W1 stored in the memory unit 110 is not limited to the time (=1/fh) which is ½ of the swing cycle of the high-speed scanning element 42a, and may be a cycle which is integer times as long as ½ of the swing cycle of the high-speed scanning element 42a and does not suppress a frequency band necessary for the vertical drive signal 16.

(Second Waveforms W2, W2′)

As described previously, while the period of the first waveform W1 portion of the vertical drive signal 16 changes corresponding to the resonance frequency fr of the high-speed scanning element 42a, the cycle of the vertical drive signal 16 is suppressed to 1/60 seconds ±0.5% and hence, it is necessary to change periods of the second waveform W2, W2′ portions of the drive signal corresponding to the resonance frequency fr of the high-speed scanning element 42a.

It may be also possible to change the cycle of the vertical drive signal 16 to 1/60 seconds ±0.5% by changing the periods of the second waveform W2, W2′ portions of the vertical drive signal 16 by changing readout timing of the second waveforms W2, W2′ corresponding to the resonance frequency fr of the high-speed scanning element 42a. However, as mentioned previously, the low-speed scanning element 44a has the natural resonance frequency so that it is necessary for the vertical drive signal 16 to suppress the resonance frequency component of the low-speed scanning element 44a. Simple changing of the readout timing of the second waveforms W2, W2′ brings about a change in a frequency component of the vertical drive signal 16 thus giving rise to a possibility that a resonance frequency component of the low-speed scanning element 44a cannot be suppressed.

In view of the above, plural kinds of second waveforms W2-1, W2′-1 to W2-n, W2′-n (n being an integer of 2 or more, here, n=11) are stored in the third ROM 103 corresponding to the resonance frequency fr of the high-speed scanning element 42a, and the waveform corresponding to the resonance frequency fr of the high-speed scanning element 42a detected by the swing state detection part 42d can be selected among the different waveforms.

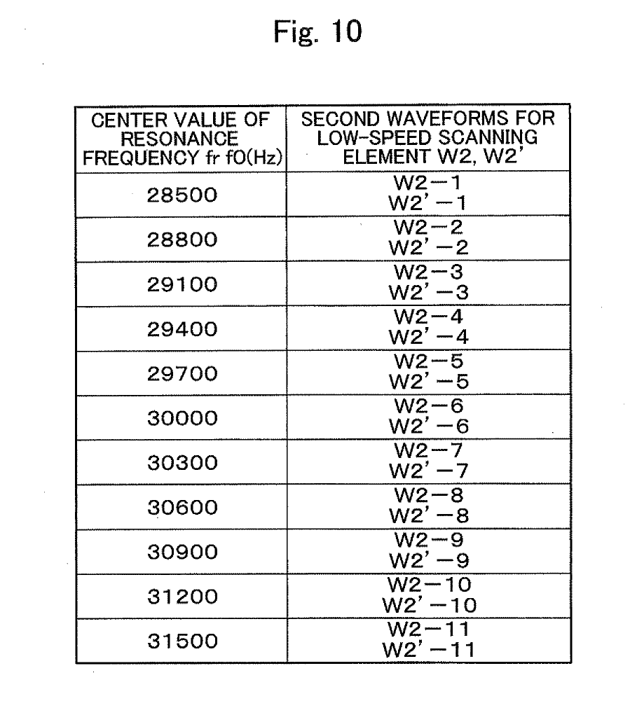

A second waveform table shown in FIG. 10 is stored in the third ROM 103 of the memory unit 110. The second waveform table is a table where the resonance frequency fr of the high-speed scanning element 42a is associated with data names of the second waveforms W2-1, W2′-1 to W2-11, W2′-11 in accordance with every 300 Hz.

The CPU 100 determines the data names of the second waveforms W2, W2′ corresponding to the resonance frequency fr of the high-speed scanning element 42a notified by the swing state detection part 42d based on the second waveform table, and reads data on the second waveforms W2, W2′ corresponding to the determined data names of the second waveforms W2, W2′ from the third ROM 103.

Reading of the data on the second waveforms W2, W2′ from the third ROM 103 is executed at timing continuous with the timing at which the first waveform W1 is read. This timing may be the timing which is ½ (=1/fh) of the swing cycle of the high-speed scanning element 42a or the timing which is integer times as long as ½ of the swing cycle of the high-speed scanning element 42a and does not suppress a frequency band necessary for the vertical drive signal 16.

By executing such processing, the vertical drive signal 16 which suppresses a signal component having resonance frequency intrinsic to the low-speed scanning element 44a can be reproduced with high accuracy. It is often the case that the resonance frequency fr of the high-speed scanning element 42a changes gently rather than changing rapidly and hence, in this embodiment, the first waveform W1 and the second waveforms W2, W2′ are read from the second and third ROMs 102, 103 and are stored in the RAM 104 as drive signal data. However, the reading of the waveforms is not limited to the above. For example, without storing the first waveform W1 and the second waveforms W2, W2′ in the RAM 104, the first waveform W1 and the second waveforms W2, W2′ may be directly read from the second and third ROMs 102, 103 and may be converted into analogue signals by the D/A converter 108.

Although the second waveforms W2, W2′ have been explained as two waveforms heretofore, the second waveforms W2, W2′ are formed continuously (see FIG. 8) and hence, these waveforms may be stored in the third ROM 103 as one waveform W2″ (W2+W2′). Further, the first waveform W1 and the second waveforms W2, W2′ may be stored in the third ROM 103 as one waveform and may be read as a separate waveform by an address control or the like at the time of reading. It is needless to say that a plurality of first waveforms may be stored in the third ROM 103.

(Adjustment of Brightness of Image Light)

When the number of invalid scanning lines n1 is changed corresponding to the resonance frequency fr of the high-speed scanning element 42a as described previously, a rate of the number of valid scanning lines n2 with respect to the total number of scanning lines N also changes. During 1 vertical scanning period Tv of the low-speed scanning element 44a, the change in the vertical scanning frequency of the low speed scanning element 44a is set to an approximately fixed value by suppressing the change within a predetermined range and hence, when the resonance frequency fr of the high-speed scanning element 42a changes, a time during which an image light is irradiated from a light source part 20 changes so that the brightness of a display image also changes.

Accordingly, the control part 13 stores a brightness table in which the resonance frequency of the high-speed scanning element and a brightness correction rate Kj are associated with each other in the third ROM 103.

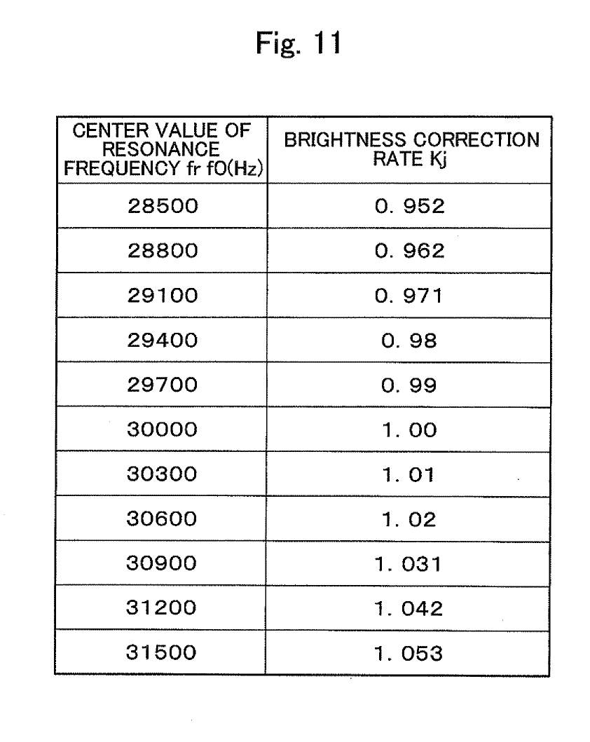

In this brightness table, as shown in FIG. 11, the resonance frequency of the high-speed scanning element 42a and the brightness correction rate Kj are associated with each other at intervals of 300 Hz. Accordingly, by looking up this brightness table, the CPU 100 changes the brightness correction rate Kj corresponding to the resonance frequency fr of the high-speed scanning element 42a thus changing brightness information on an image signal outputted to the image signal supply circuit 11. For example, when the resonance frequency fr of the high-speed scanning element 42a is 28500 Hz, the CPU 100 outputs an image signal to the image signal supply circuit 11 by multiplying intensities of respective brightness signals of the image signal by 0.952 times. When a swing range of the high-speed scanning element 42a changes corresponding to the resonance frequency, it is also necessary to adjust an amount of the change.

By changing the brightness of light corresponding to an image signal corresponding to the resonance frequency of the high-speed scanning element 42a, it is possible to prevent the brightness of an image to be displayed from changing corresponding to the resonance frequency and hence, quality of the image to be displayed can be maintained.

(Control of Optical Scanning Part 40 by the Control Part 13)

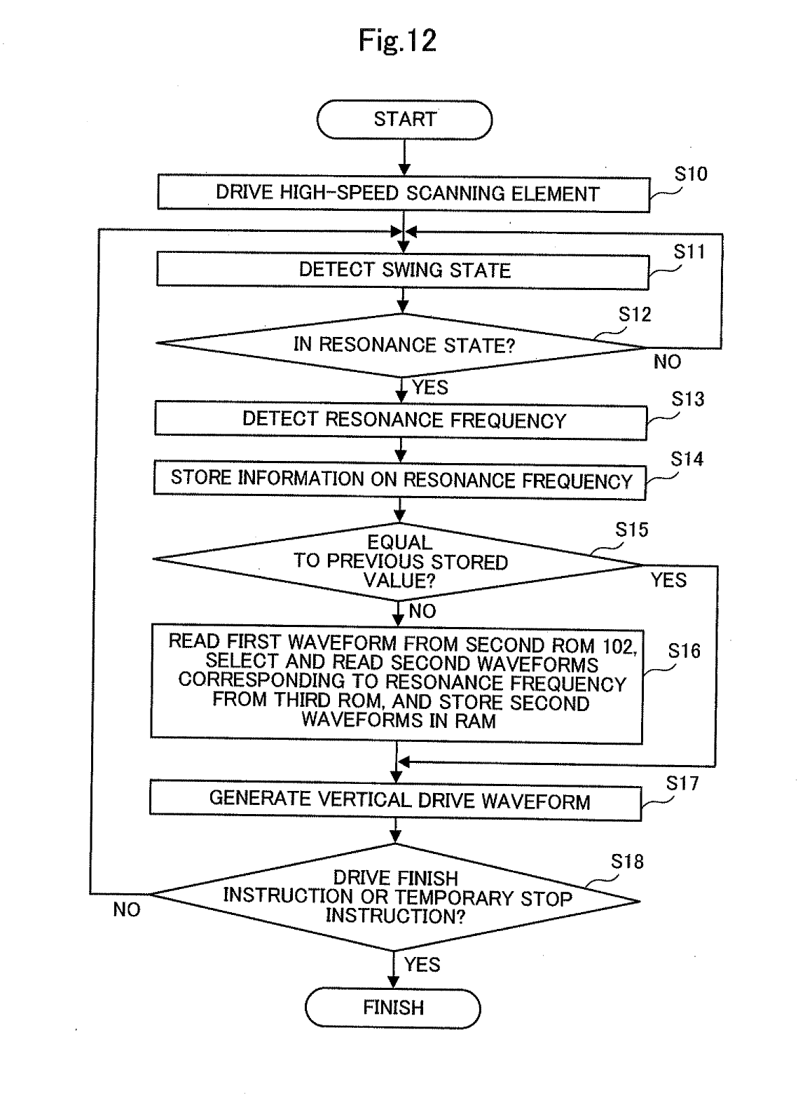

A control of the optical scanning part 40 by the control part 13 of the image display device 1 having the above-mentioned constitution is explained in conjunction with an operational flowchart shown in FIG. 12.

As shown in FIG. 12, when the control part 13 starts a control operation, firstly, the CPU 100 inputs a predetermined horizontal drive signal 15 (for example, a horizontal drive signal 15 of 30000 Hz) into the high-speed scanning element 42a so that the high-speed scanning element 42a starts the swinging of the reflection mirror 42b (step S10).

Next, the CPU 100 acquires information on swing frequency, magnitude, and a phase difference of the swing and the like of the reflection mirror 42b of the high-speed scanning element 42a from the swing state detection part 42d, and changes frequency or amplitude of the horizontal drive signal 15 (step S11).

Thereafter, the CPU 100 determines whether or not the high-speed scanning element 42a is brought into a resonance state (step S12). Here, when magnitude of swinging of the reflection mirror 42b of the high-speed scanning element 42a or the phase difference between the horizontal drive signal 15 and a swing state falls within a predetermined range, the CPU 100 determines that the high-speed scanning element 42a is brought into a resonance state, while when magnitude of swinging of the reflection mirror 42b of the high-speed scanning element 42a or the phase difference falls outside the predetermined range, the CPU 100 determines that the high-speed scanning element 42a is not brought into a resonance state.

When the CPU 100 determines that the high-speed scanning element 42a is not brought into a resonance state (step S12: No), the CPU 100 returns to step S11 again so as to wait for the high-speed scanning element 42a being brought into a resonance state. In a case where the high-speed scanning element 42a is not brought into a resonance state even when a predetermined time elapses, the CPU 100 stops driving of the high-speed scanning element 42a.

On the other hand, when the CPU 100 determines that the high-speed scanning element 42a is brought into a resonance state (step S12: Yes), the CPU 100 detects resonance frequency of the high-speed scanning element 42a (step S13). That is, the CPU 100 sets the frequency of the horizontal drive signal 15 inputted to the high-speed scanning element 42a in a resonance state as resonance frequency of the high-speed scanning element 42a. The CPU 100 stores, then, information on the resonance frequency of the high-speed scanning element 42a in the RAM 104 (step S14).

Next, the CPU 100 determines whether or not a value (stored value) of the resonance frequency stored in the current step S14 and a value (stored value) of the resonance frequency stored in the previous step S14 are equal (step S15). Here, an initial value (stored value) of resonance frequency stored in the RAM 104 is 30000 Hz. Accordingly, when processing in step S15 is executed firstly, the CPU 100 determines whether or not the initial value is equal to the current stored value.

When the CPU 100 determines that the previous stored value and the current stored value are not equal to each other (step S15: No), the CPU 100 reads the first waveform W1 from the second ROM 102, and selects and reads the second waveforms W2, W2′ corresponding to the current stored value (resonance frequency of the high-speed scanning element 42a) from the third ROM 103. Then, the CPU 100 forms drive signal data by connecting the second waveform W2, the first waveform W1 and the second waveform W2′ which are read, and stores the drive signal data in the RAM 104 (step S16). On the other hand, when the CPU 100 determines that the previous stored value and the current stored value are equal (step S15: Yes), the CPU 100 does not perform processing in step S16.

Then, the CPU 100 generates a vertical drive signal 16 (step S17). That is, the CPU 100 sequentially reads drive signal data stored in the RAM 104 in response to a readout clock signal at a cycle decided based on the resonance frequency of the high-speed scanning element 42a, and inputs the drive signal data into the D/A converter 108 thus generating and outputting a vertical drive signal 16. The CPU 100 may directly read the first waveform W1 and the second waveforms W2, W2′ from the second and third ROMs 102, 103 without storing drive signal data in the RAM 104. In this case, the CPU 100 selects the second waveforms W2, W2′ corresponding to the current stored value (resonance frequency of the high-speed scanning element 42a) in step S16. Then, the CPU 100 sequentially reads respective data consisting of data on the second waveform W2 selected in step S16 out of the second waveform W2 stored in the third ROM 103, data on the first waveform W1 stored in the second ROM 102, and data on the second waveform W2′ selected in step S16 out of the second waveform W2′ stored in the third ROM 103 in this order in response to a readout clock signal of a cycle decided based on the resonance frequency of the high-speed scanning element 42a. The CPU 100 inputs the readout clock signal into the D/A converter 108 and makes the D/A converter 108 output a vertical drive signal 16.

The above-mentioned processing is continued until a drive finish instruction or a temporary stop instruction is issued by a user (step S18).

In this manner, in the image display device 1, the CPU 100 acquires information on the resonance frequency fr of the high-speed scanning element 42a from the swing-state detection part 42d, and sequentially reads data on the first waveform W1 stored in the memory unit 110 in response to a readout clock signal of a cycle decided based on the resonance frequency. Then, the CPU 100 generates a vertical drive signal 16 of a first waveform W1 portion by inputting the data read in this manner into the D/A converter 108. Then, the CPU 100 sequentially reads, out of data on a plurality of second waveforms W2-1, W2′-1 to W2-11 and W2′-11 which are stored in the memory unit 110 corresponding to the resonance frequency of the high-speed scanning element 42a, data on the second waveforms W2, W2′ which maintains a change in a cycle of a sawtooth waveform within a predetermined time from the memory unit 110 at readout timing of a cycle corresponding to the resonance frequency of the high-speed scanning element 42a and inputs the data into the D/A converter thus generating a vertical drive signal 16 of a second waveform portion.

Accordingly, a change in vertical scanning frequency caused by a change or irregularities in resonance frequency or the like of the high-speed scanning element can be suppressed so that frequency can be set to an approximately fixed value, and a swing state of the low-speed scanning element 44a can be easily made stable. Further, the second waveforms W2, W2′ are turned into waveforms where a component of resonance frequency intrinsic to the low-speed scanning element 44a is suppressed whereby it is possible to suppress the induction of resonance oscillations of the reflection mirror 44b of the low-speed scanning element 44a.

Although several embodiments of the present invention have been explained in detail based on drawings, these embodiments are provided only as examples, and the present invention can be carried out in other modes to which various modifications and improvements are applied based on the knowledge of those who are skilled in the art.

For example, in the above-mentioned embodiment, the explanation has bee made by taking the low-speed scanning element 44a where the reflection mirror 44b is swingably supported on the fixed member by way of the resilient beam member 44b as an example. However, the present invention is not limited to such a constitution, and is also applicable to any low-speed scanning element which has natural resonance frequency. In the above-mentioned embodiment, the example where the drawback on the natural resonance of the low-speed scanning element is also overcome is named, and such an example is named as the most effective example. However, even when the waveform stored in the memory unit is not a waveform which suppresses a natural resonance, the waveform does not depart from the gist of the present invention. That is, the constitution where a change in drive frequency (sub scanning frequency) of the low-speed scanning element which occurs due to a change in frequency of the high-speed scanning element can be suppressed within a fixed range is also included in the embodiment of the present invention as a matter of course.

Further, in the above-mentioned embodiment, the explanation has been made with respect to the example where data on plural kinds of second waveforms is stored in the memory unit corresponding to resonance frequency of the high-speed scanning element, and data on a kind of second waveform corresponding to the resonance frequency of the high-speed scanning element is read from the memory unit thus generating a drive signal for the second waveform portion. However, the present invention is not limited to such an example, and it is sufficient that data on the second waveform corresponding to the resonance frequency of the high-speed scanning element is sequentially read at readout timing corresponding to the resonance frequency thus generating a drive signal for the second waveform portion corresponding to the resonance frequency of the high-speed scanning element. For example, only one kind of second waveform may be stored in the memory unit. In this case, data on the second waveform where the resonance frequency of the high-speed scanning element is the highest (data in which the number of constituting data is the largest, in other words, data having the waveform with the longest period) is prepared and a readout address of the data and the number of data are changed corresponding to the resonance frequency of the high-speed scanning element. By executing such processing, a quantity of data on the second waveform stored in the memory unit can be decreased. Although data which is read or is not read corresponding to a change in resonance frequency of the high-speed scanning element exists in this case, it is preferable to set data on a portion of the second waveform continuous with the first waveform to a value equal to a data value of the first waveform or a value which approximates the data value of the first waveform.

Further, in the above-mentioned embodiment, with respect to the vertical drive signal 16, the waveform of the portion during the vertical valid scanning period Tv1 is set as the first waveform, and the waveforms of the portions during the vertical invalid scanning periods Tv2-1, Tv2-2 are set as the second waveform. However, it is sufficient that the first waveform includes the waveform of the portion during the vertical valid scanning period Tv1, and it is not always necessary that the first waveform is completely equal to the waveform of the portion during the vertical valid scanning period Tv1.

Further, in the above-mentioned embodiment, the resolution of a display image is set to 800×600 pixels, the designed value of the resonance frequency of the high-speed scanning element 42a is set to 30 kHz, the total number of scanning lines N is set to 1000, irregularities (change) in resonance frequency of the high-speed scanning element 42a is set to ±5% (30 kHz±1500 Hz), and a change amounting to approximately 1% of resonance frequency fr (300 Hz) is set as 1 unit. However, these specific values are used for the sake of brevity, and it is needless to say that the present invention is not limited to these values.

Further, in the above-mentioned embodiment, the explanation has been made by taking the signals having waveforms shown in FIG. 3 as examples of the sawtooth waveform signal. However, it is sufficient for the sawtooth waveform signal to have a cyclic waveform which includes an approximately straight-line portion for scanning light. For example, cyclic waveform may be a triangular waveform, a trapezoidal waveform, a sinusoidal waveform or the like.

What is claimed is:

1. An image display device which displays an image by two-dimensionally scanning light having intensity corresponding to an image signal, the image display device comprising:
a light source part which is configured to irradiate the light having the intensity corresponding to the image signal;
a resonance-type high-speed scanning element which is configured to scan the light incident on the high-speed scanning element at a relatively high speed in a first direction by a reflection mirror which resonates;
a low-speed scanning element which is configured to incline a reflection mirror in a direction corresponding to a signal level of a drive signal to be inputted, and is configured to scan the light incident on the low-speed scanning element at a relatively low speed in a second direction approximately perpendicular to the first direction by the reflection mirror;
a detection part which is configured to detect resonance frequency of the high-speed scanning element;
a drive signal generation part which is configured to generate a drive signal having a sawtooth waveform corresponding to resonance frequency of the high-speed scanning element; and
a low-speed scanning element drive part which is configured to input the drive signal generated by the drive signal generation part to the low-speed scanning element, wherein
the drive signal generation part includes a memory unit which stores data on a first waveform for effectively scanning light out of a sawtooth waveform of the drive signal, and stores data on a second waveform which is a waveform formed by excluding the first waveform from the sawtooth waveform of the drive signal, and
the drive signal generation part is configured to sequentially read data on the first waveform stored in the memory unit at readout timing corresponding to resonance frequency of the high-speed scanning element and to generate a portion of the drive signal corresponding to the first waveform, and is configured to sequentially read data on the second waveform stored in the memory unit at readout timing corresponding to the resonance frequency of the high-speed scanning element and to generate a portion of the drive signal corresponding to the second waveform corresponding to the resonance frequency of the high-speed scanning element thus maintaining a change in a cycle of the sawtooth waveform within a predetermined time.

2. The image display device according to claim 1, wherein the drive signal generation part is configured to set the total number of data on the first waveform portion read at the readout timing to a fixed value, and changes the total number of data on the second waveform portion read at the readout timing corresponding to the resonance frequency of the high-speed scanning element.

3. The image display device according to claim 2, wherein plural kinds of data on the second waveform are stored in the memory unit corresponding to the resonance frequency of the high-speed scanning element, and
the drive signal generation part is configured to read a kind of data on the second waveform corresponding to the resonance frequency of the high-speed scanning element from the memory unit, and to generate the drive signal corresponding to the second waveform portion.

4. The image display device according to claim 1, wherein a cycle of the readout timing is a time which is ½ of a swing cycle of the high-speed scanning element or a time which is integer times as long as ½ of the swing cycle of the high-speed scanning element, and does not suppress a frequency band of the drive signal.

5. The image display device according to claim 1, wherein the predetermined time is a time of a cycle of 1 scanning by the high-speed scanning element.

6. The image display device according to claim 1, wherein the light source part changes brightness of light corresponding to the image signal corresponding to resonance frequency of the high-speed scanning element thus suppressing a change in brightness of an image to be displayed corresponding to the resonance frequency.
